(19) United States
(12) Patent Application Publication
(10) Pub. No.: US 2015/0031570 A1
(43) Pub. Date: Jan. 29, 2015

(54) METHOD AND APPARATUS FOR RAPID, HIGH SENSITIVITY ANALYSIS OF LOW VOLUME SAMPLES OF BIOLOGICAL MATERIALS

(71) Applicant: Douglas Scientific, LLC, Alexandria, MN (US)

(72) Inventors: Paul Howard Wagner, Alexandria, MN (US); Adnanul Haq, Alexandria, MN (US); Richard Jerome Schoeneck, Alexandria, MN (US)

(21) Appl. No.: 14/376,579

(22) PCT Filed: Feb. 4, 2013
(86) PCT No.: PCT/US13/24633

§ 371 Date: Aug. 4, 2014

Related U.S. Application Data
(60) Provisional application No. 61/633,031, filed on Feb. 4, 2012.

(51) Int. Cl. G01N 35/02; G01N 21/64

(52) U.S. Cl. CPC G01N 35/028; G01N 21/6452; G01N 2035/0403
USPC 506/9; 506/39

(57) ABSTRACT

A high throughput biological sample processing system includes a sample carrier with a plurality of wells that progresses through the high throughput biological sample processing system. The system further includes a sample dispensing module, a reagent dispensing module, an accumulation/incubation module, and a detection module. The detection module employs an optical measuring device to encapsulate a biological sample in one of the plurality of wells of the sample carrier and detect energy from the chemistry of the biological sample to determine the amount of an analyte in the biological sample.

### BACKGROUND

The present invention relates to high throughput biological material sample analysis, and specifically to using an anidolic optical measuring device to detect biological or chemical sample emissions.

Advances in the biosciences industry have created a demand for high throughput biological sample processing and detection systems. For example, Astle, U.S. Pat. No. 6,632,653 discloses a high throughput method of performing biological assays using a carrier tape. Currently, such systems require relatively high chemical volumes due to lack of sensitivity of the detection instrumentation. Furthermore, although current systems may be able to handle a large number of samples, such systems take a long time to process these samples. The combination of lack of sensitivity and lengthy sample processing time lead to an undesirably high processing cost per sample analyzed. Lowering costs requires increased sensitivity of detection systems and the ability to use a single detection system to measure sample emissions that exhibit non-uniform radiance patterns, which vary from sample to sample.

### SUMMARY

A high throughput biological sample processing system includes a sample carrier with a plurality of wells that progresses through the high throughput biological sample processing system. The system further includes a sample dispensing module, a reagent dispensing module, an accumulation/incubation module, and a detection module. The detection module employs an optical measuring device to encapsulate a biological sample in one of the plurality of wells of the sample carrier and detect energy from the chemistry of the biological sample to determine the amount of an analyte in the biological sample.

An apparatus for detecting an analyte in a biological sample in a sample carrier with wells includes an upper optic assembly with an optical measuring device and a lower optic assembly for receiving the sample carrier. The optical measuring device encapsulates a biological sample in one of the wells of the sample carrier and detects energy from a chemistry of the biological sample to determine the amount of the analyte in the biological sample.

A method of detecting the amount of an analyte in a biological sample in a sample carrier with wells includes feeding the sample carrier into a detection apparatus including an optical measuring device. The optical measuring devices includes an upper optic assembly with a projecting element and a lower optic assembly for receiving the sample carrier. The method further includes clamping the lower optic assembly to the upper optic assembly to encapsulate a biological sample in one of the wells of the sample carrier and detecting energy from a chemistry of the biological sample to determine the amount of the analyte in the biological sample.

### BRIEF DESCRIPTION OF THE DRAWINGS

FIG. 1 is a front view of the high throughput system of the present invention.

FIG. 2 is a perspective view of the continuous medium of the high throughput system of the present invention.

FIG. 3 is a cross-sectional view of the detection module of the high throughput system of the present invention.

FIG. 4 is a front view of the accumulation/incubation module of the high throughput system of the present invention.

### DETAILED DESCRIPTION

The high throughput system of the present invention includes fluid handling, processing, and anidolic scanning of biological material samples. The high throughput system analyzes biological material in solution to determine the amount of targeted analytes. The high throughput system performs inline sampling, where a biological material is dispensed, reagents are added, the samples are incubated for a specified amount of time to carry out a reaction, and the reaction is scanned to produce the result. The high throughput system is particularly suited for the room temperature incubation homogeneous enzyme-linked immunosorbent assay (ELISA). The detection module of the high throughput system efficiently collects light emitted by the reaction using an optical measuring device. The optical measuring device may be an anidolic optical measuring device, allowing for detection of non-uniform or uniform radiance patterns and allowing for detection of weaker signals.

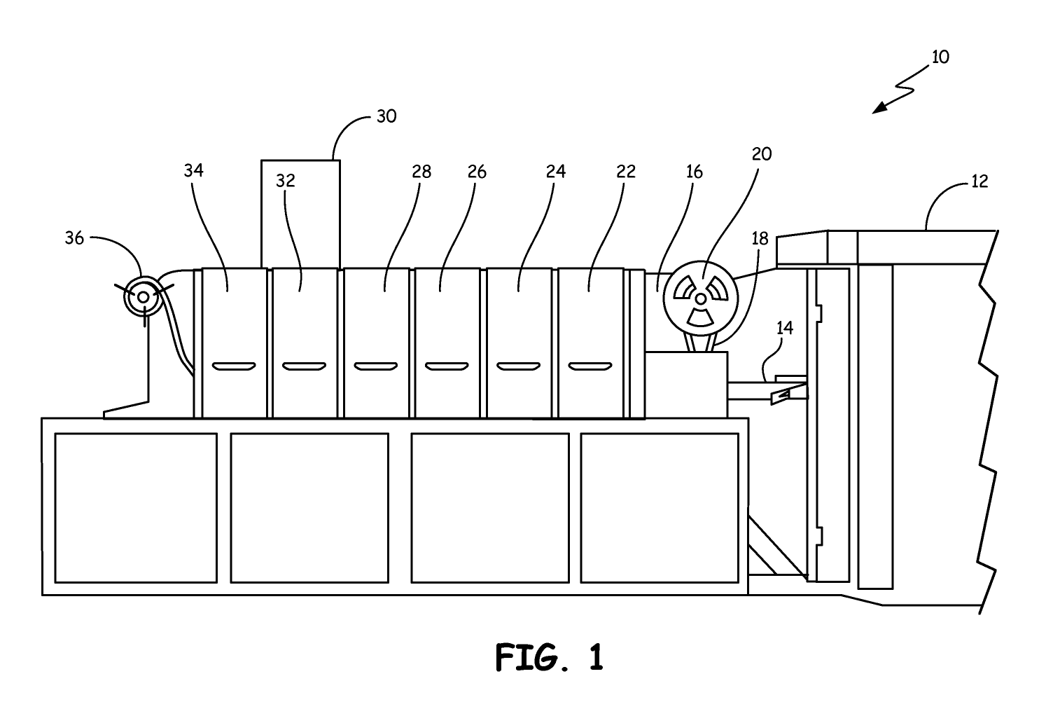

FIG. 1 is a front view of high throughput system 10. High throughput system 10 includes plate storage module 12, arm assembly 14, and unwind module 16. Unwind module 16 includes continuous medium 18 and unwind reel 20. High throughput system 10 further includes sample dispensing module 22, reagent reservoir module 24, reagent dispensing module 26, sealing module 28, accumulation/incubation module 30, light resistant cover 32, detection module 34, and rewind module 36.

Referring to FIG. 1, plate storage module 12 stores micro-well plates containing biological material for analysis, such as prepared solutions of plant, animal DNA, rNA, or cellular material. Plate storage module 12 may store micro-well plates with 96 wells, 384 wells, 1536 distinct wells, or any other suitable number of wells. Plate storage module 12 is controlled by an electronic control system of high throughput system 10. Plate storage module 12 may be configured to control the temperature of biological material above ambient temperatures, such as 37 degrees Celsius, or may be configured to refrigerate biological material.

To begin the high throughput process, the electronic control system of high throughput system 10 signals plate storage module 12 to transfer one or more micro-well plates to unwind module 16 using arm assembly 14. The biological material in the micro-well plates is subsequently transferred to continuous medium 18, which is unwound from unwind reel 20. Continuous medium 18 may be an array tape with arrays of 96 wells, 384 wells, or 1536 wells. In alternative embodiment, continuous medium 18 may be replaced with segments or sheets of wells as the carrier for the biological samples. In sample dispensing module 22, the biological material is transferred to continuous medium 18 using a commercial liquid handling pipette configured to dispense into 96 wells, 384 wells, or 1536 wells. The sample volume transferred is typically 10 micro-liters or 25 micro-liters. The pipette tips of the commercial liquid handling pipette may be washed prior to aspirating and dispensing the biological material sample into continuous medium 18 in order to prevent contamination.

Once the biological material sample from a storage plate is transferred into an array of continuous medium 18, continuous medium 18 continues to progress through high throughput system 10, allowing a new empty array of continuous medium 18 to be positioned for filling with another biological material sample. When a storage plate from plate storage module 12 is no longer required, it is transferred back to plate storage module 12. Once adequately filled with a biological material sample, continuous medium 18 progresses from sample dispensing module 22 to reagent dispensing module 26. Reagent dispensing module 26 dispenses a reagent from reagent reservoir module 24 into the array of continuous medium 18 containing the biological sample. In an alternative embodiment, reagent dispensing module 26 dispenses a reagent into continuous medium 18 prior to the addition of a biological sample to continuous medium 18.

After dispensing, continuous medium 18 proceeds to sealing module 28, where continuous medium 18 may be sealed with a cover seal. In an alternative embodiment, a cover seal is not applied to continuous medium 18. The cover seal may prevent contamination and evaporation from the wells of continuous medium 18 while the reaction is taking place. After a cover seal is applied, continuous medium 18 progresses to accumulation/incubation module 30 to allow the desired chemical reaction to take place. Accumulation/incubation module 30 includes light resistant cover 32 for protecting continuous medium 18 from light exposure during the chemical reaction, because some chemistries are compromised by the presence of even small amounts of light.

Accumulation/incubation module 30 may include thermal control to carry out the desired reaction at above or below room temperature. Accumulation/incubation module 30 may also include humidity control in order to prevent evaporation and an undesired volume change in the wells of continuous medium 18, particularly if no cover seal is applied in sealing module 28. In an alternative embodiment, high throughput system 10 may include thermal and humidity control in every module in order to more effectively prevent evaporation and ensure reaction accuracy and efficiency.

Depending on the chemistry carried out in high throughput system 10, high throughput system 10 may include more than one reagent dispensing module 26 and accumulation/incubation module 30. For example, ELISA chemistry requires two of reagent dispensing module 26 and two of accumulation/incubation module 30 in order to detect analytes such as insulin, VEGF, Aβ40, Aβ42, IgG, EPO, TNFα and HIV p24. In the first reagent dispensing module 26, anti-analytes and acceptor beads are added to the biological material samples in continuous medium 18. Continuous medium 18 is not yet sealed, because further reagents need to be added in the second reagent dispensing module 26. Continuous medium 18 then accumulates and incubates in the first accumulation/incubation module 30 to allow the acceptor beads and anti-analytes to bind to the biological material. The first accumulation/incubation module 30 may include thermal control. In an alternative embodiment, the first accumulation/incubation module 30 may also include humidity control in order to prevent a volume change due to evaporation.

Subsequently, continuous medium 18 proceeds to the second reagent dispensing module 26, where donor beads are added to the biological material samples. Continuous medium 18 then proceeds to sealing module 28 and into the second accumulation/incubation module 30, where the donor beads bind to the acceptor beads if the desired analyte is present in the biological material samples in continuous medium 18. The more analyte present in the biological material sample, the more donor beads bind to acceptor beads, which will result in a stronger signal in detection module 34. After continuous medium 18 accumulates and incubates in accumulation/incubation module 30, continuous medium 18 proceeds to detection module 34.

Each sample-containing well of continuous medium is analyzed in detection module 34. The chemistry in continuous medium 18 is excited with an excitation source, such as a laser, and the photons coming off the chemistry are counted for a specific time period in order to determine the amount of the desired analyte in the biological material sample. Detection module 34 is configured to prevent light penetration that would interfere with light emission and detection of a desired analyte in the chemistry in continuous medium 18. Detection module 34 may use an anidolic design in order to precisely measure sample energy emissions that exhibit both uniform and non-uniform radiance patterns. Detection module 34 may precisely measure a total sample volume where each fraction of the entire sample volume is equally weighted in a single measurement.

After an entire array of continuous medium 18 is scanned in detection module 34, continuous medium 18 is rewound for disposal in rewind module 36. The entire high throughput process in high throughput system 10 is controlled via computer software that monitors the environmental controls and reaction progression in high throughput system 10. The computer software creates files with results for each array of continuous medium 18 that is processed by high throughput system 10.

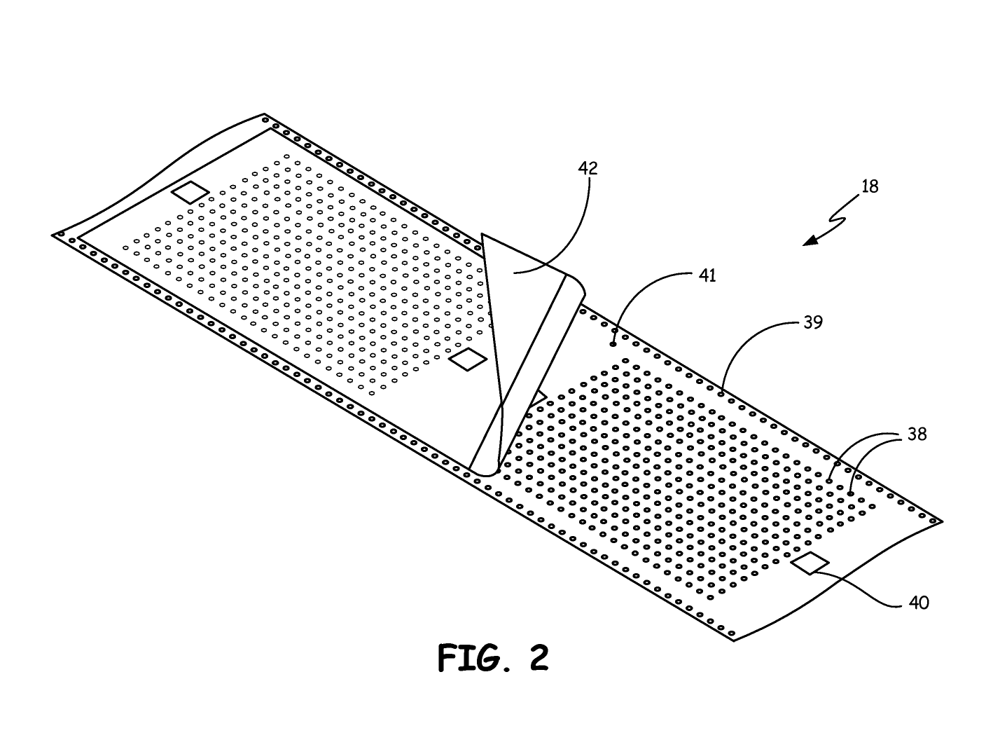

FIG. 2 is a perspective view of continuous medium 18. Continuous medium 18 includes wells 38, indexing pattern 39, machine readable code 40 (such as a bar code), orientation marker 41, and cover seal 42. Wells 38 may be in an array pattern with 96 wells, 384 wells, or 1536 wells per array. Continuous medium 18 may be a continuous carrier tape. Continuous medium 18 may include indexing pattern 39 for motion translation and centering of continuous medium 18 in high throughput system 10. Indexing pattern 39 may perforate continuous medium 18 in order to assist in motion translation and centering of continuous medium 18. Machine readable code 40 provides for the tracking activity of each of wells 38 in each array. Machine readable code 40 is placed at both ends of each array and allows confirmation of the identity of the array set regardless of which direction continuous medium 18 is fed into high throughput system 10. Orientation marker 41 is placed on only one end of each array in order to provide information as to which direction continuous medium 18 is fed through high throughput system 10. Cover seal 42 is provided when sealing of a biological material sample and reagents is required for the specific reaction taking place.

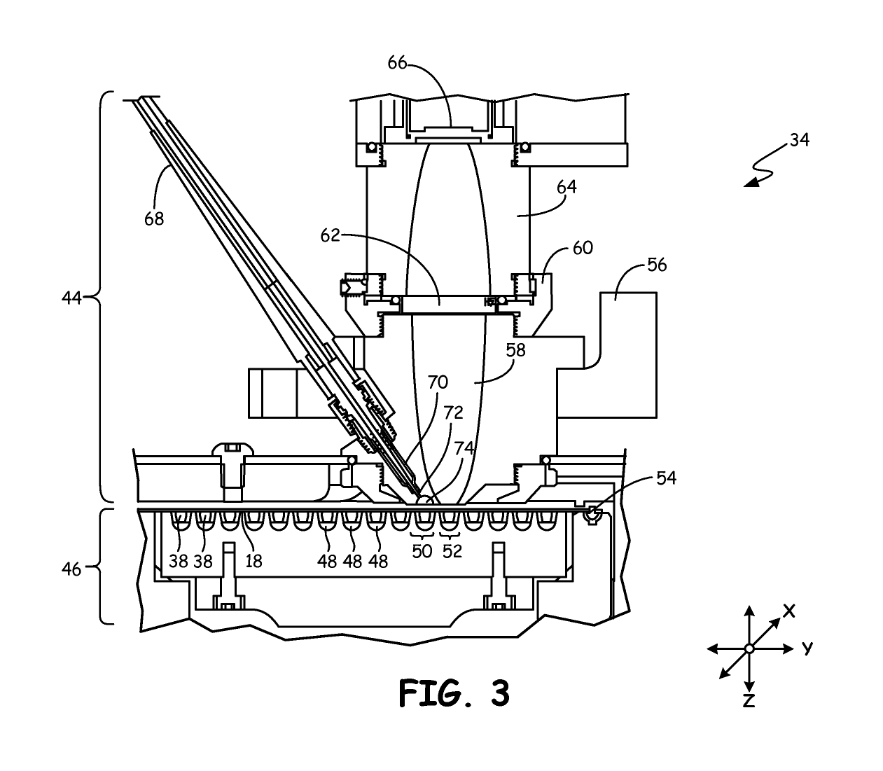

FIG. 3 is a cross sectional view of detection module 34. Detection module 34 includes upper optic assembly 44 and lower optic assembly 46, which make up the optical measuring apparatus of the present invention. Lower optic assembly 46, which receives and supports continuous medium 18 with wells 38, includes integrating element 48, excitation position 50, emission position 52, and drive belt 54. Upper optic assembly 44 includes main optic bracket 56, projecting element 58, swivel coupling/filter holder 60 containing emission filter 62, focus mirror element 64, detector active sensing area 66, laser 68, spring loaded tip sheath 70, fiber optic tip 72, and excitation diffuser 74. Projecting element 58 preferably has a compound parabola shape and is highly reflective and highly specular. Spring loaded tip sheath 70 protects the chisel shape of fiber optic tip 72. The chisel shape of fiber optic tip 72 allows emission of two side-shooting beams into excitation diffuser 74. Fiber optic tip 72 may employ facets that are 34 degrees from a central axis of fiber optic tip 72. Excitation diffuser 74 may be highly reflective. Excitation diffuser 74 may also have a spherical shape.

Detection module 34 scans each of wells 38, beginning with the well in the first column and first row of the array of continuous medium 18. Drive belt 54 advances continuous medium 18 through detection module 34. Scanning begins with the first row of the first column and advances down each row in the first column. Once detection module 34 has scanned every row in the first column, drive belt 54 advances continuous medium 18 to scan the first row of the second column, and continuous medium 18 continues to progress through detection module 34 in this manner until each of wells 38 has been scanned. Lower optic assembly 46 is movable up and down along the z-axis. When lower optic assembly 46 is raised, lower optic assembly 46 lifts continuous medium 18 and clamps continuous medium 18 between lower optic assembly 46 and upper optic assembly 44.

When continuous medium 18 progresses through detection module 34, lower optic assembly 46 lowers integrating element 48 to be free and clear of continuous medium 18. Upper optic assembly 44 is moved along the y-axis and positioned such that excitation diffuser 74 aligns with the first row of wells 38. Simultaneously, continuous medium 18 is advanced along the x-axis by drive belt 54 so that the desired column of wells 38 aligns with integrating element 48. This results in one of wells 38 in excitation position 50 and another of wells 38 in emission position 52. Once alignment is complete, lower optic assembly 46 is raised in order to raise integrating element 48 and clamp continuous medium 18 against upper optic assembly 44. In an alternative embodiment, lower optic assembly does not include integrating elements 48 and continuous medium 18 acts as the integrating element. Integrating element 48 may have a spherical shape. Integrating element 48 may also be optically diffusing. Integrating element 48 may also be highly reflective.

Laser 68 is then energized for a user-defined excitation time and the chemistry in excitation position 50 is excited by laser energy typically at 680 nm. Laser 68 may be energized for up to 0.5 seconds. The time period laser 68 is energized may be dependent upon the strength of the chemistry. For example, if a lot of donor beads bind a lot of acceptor beads in ELISA chemistry, laser 68 should be energized for a shorter period of time to prevent overloading detection module 34. In an alternative embodiment, if there is a very low level of analyte in the sample, laser 68 may be energized for longer than 0.5 seconds in order to produce detectable emission.

Laser 68 is then turned off and lower optic assembly 46 is lowered to unclamp continuous medium 18 from upper optic assembly 44. Main optic bracket 56 moves projecting element 58 along the y-axis into excitation position 50, which thus becomes emission position 52. Lower optic assembly 46 again raises integrating element 48 to clamp continuous medium 18 against upper optic assembly 44. When chemistry in excitation position 50 is excited by laser 68, this may result in an autofluorescence glow from continuous medium 18. Therefore, a user-defined autofluorescence decay time is allowed to pass in order to prevent the autofluorescence from being measured along with the desired chemiluminescence of the excited sample.

Integrating element 48, projecting element 58, emission filter 62, and focus mirror element 64 make up the anidolic optical measuring device of detection module 34. The anidolic optical measuring device encapsulates the biological sample. Once the autofluorescence decay time is complete, photons emitted by the chemiluminescence of the chemistry in emission position 52 are reflected into projecting element 58, through emission filter 62, through the interior of focus mirror element 64 and into detector active sensing area 66. As the photons exit the sample, they may encounter several transitions of refraction and reflection, and as a result, the radiance pattern emitted inside integrating element 48 may be uniform or non-uniform, either of which is detectable by the anidolic optical measuring device of detection module 34. In an alternative embodiment, the fluorescence of the chemistry is detected by detection module 34. Detection preferably lasts for 0.2 seconds. In an alternative embodiment, detection may last for between 0.1 seconds and 1 second. In another embodiment, if the chemistry provides a very low level of emission, detection may last for 5 seconds.

Detection module 34 thus generates photon counts to determine the emission strength of the chemistry in emission position 52, which represents the amount of analyte present. Once the detection in emission position 52 is complete, the sample in excitation position 50 is excited by laser 68, and detection proceeds in the same manner until each of wells 38 in the desired column has been excited and scanned by detection module 34. When the last of wells 38 in the desired column has been excited, lower optic assembly 46 lowers integrating element 48 to unclamp continuous medium 18. Continuous medium 18 advances and the first row of the next column of wells 38 is positioned for scanning and detection.

Once each of wells 38 has been scanned, high throughput system 10 signals to detection module 34 that the incubation time for the next array of continuous medium 18 is complete, and the next array of continuous medium 18 is therefore advanced into detection module 34. Detection module 34 may take between 2 minutes and 5 minutes to scan an array with 16 rows and 24 columns of wells 38. Detection module 34 may include an alternate emission filter 62 in order to accommodate multiplexing for chemistries other than ELISA, which does not require filters.

Detection module 34 utilizes an optical measuring device including integrating element 48 and projecting element 58 to encapsulate one of wells 38 of continuous medium 18 to extract light emitted by the chemistry in a biological sample. By clamping continuous medium 18 to upper optic assembly 44 and encapsulating one of wells 38, a majority of photons emitted from the sample may be detected, which allows for detection of particularly weak signals as well as detection of low sample volumes.

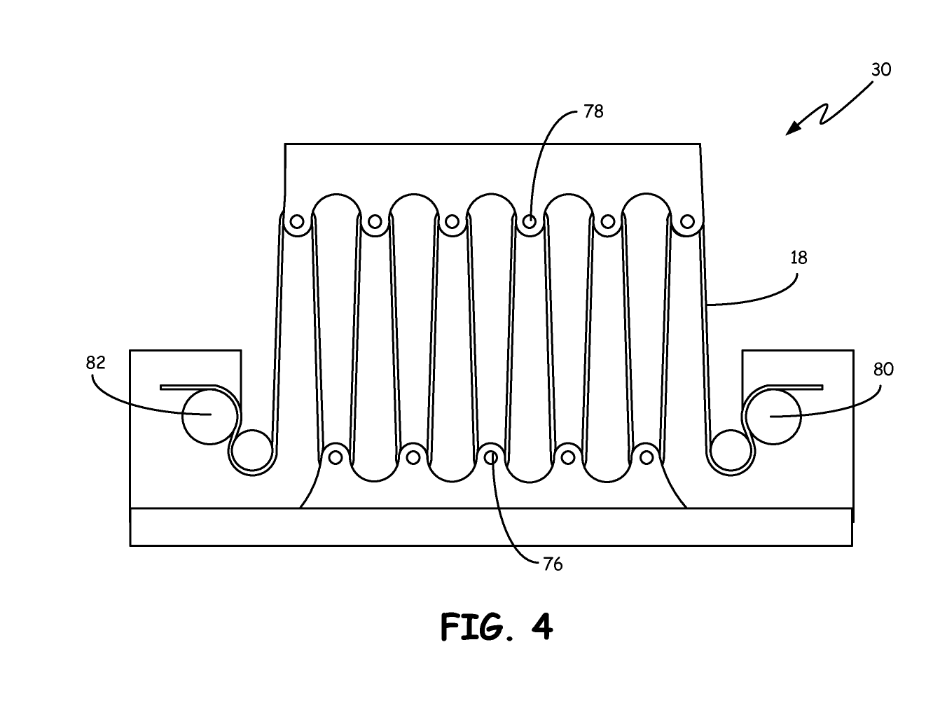

FIG. 4 is a front view of accumulation/incubation module 30. Accumulation/incubation module 30 includes continuous medium 18, bottom roller set 76, top roller set 78, tape-in drive 80, and tape-out drive 82. Continuous medium 18 enters accumulation/incubation module 30 through tape-in drive 80. Continuous medium 18 enters in a straight path but proceeds in a serpentine path through bottom roller 76 and top roller 78. Top roller 78 is movable while bottom roller 76 is static. The serpentine path allows for accumulation of continuous medium 18 in a compact space.

Continuous medium 18 exits accumulation/incubation module 30 through tape out drive 80.

When continuous medium 18 progresses through accumulation/incubation module 30, the computer system of high throughput system 10 may signal accumulation/incubation module to stop continuous medium 18 for incubation. The mobility of top roller 78 allows for controlling the number of arrays that can pass through accumulation/incubation module 30. The number of arrays passing through accumulation/incubation module 30 depends on the desired and required incubation period for the chemistry in the biological sample. Incubation/accumulation module 30 may hold continuous medium 18 for a given amount of time at a specified temperature and humidity. Incubation may occur at a temperature between room temperature and 80 degrees Celsius.

Accumulation/incubation module 30 allows the upstream and downstream processes of high throughput system 10 to work independently. In one embodiment, upstream processes such as dispensing can proceed at a rapid pace, while downstream processes such as detection can proceed at a slower pace. Accumulation/incubation module 30 also allows the upstream and downstream processes of high throughput system 10 to move in different motion profiles. In one embodiment, continuous medium 18 may be moving array-by array in the upstream process and column-by-column in the downstream process.

Although the present invention has been described with reference to preferred embodiments, workers skilled in the art will recognize that changes may be made in form and detail without departing from the spirit and scope of the invention.

1.-62. (canceled)

63. A high throughput biological sample processing system comprising:
a sample carrier with a plurality of wells that progresses through the high throughput biological sample processing system;
a sample dispensing module;
a first reagent dispensing module;
a first accumulation/incubation module; and
a detection module;
wherein the detection module employs an optical measuring device to encapsulate a biological sample in one of the plurality of wells of the sample carrier and detect energy from a chemistry of the biological sample to determine the amount of an analyte in the biological sample.

64. The high throughput biological sample processing system of claim 63, wherein the optical measuring device of the detection module is an anidolic optical measuring device which detects energy from both uniform and non-uniform radiance patterns emitted by the chemistry of the biological sample.

65. The high throughput biological sample processing system of claim 63, wherein the detection module is configured to analyze ELISA chemistry.

66. The high throughput biological sample processing system of claim 63, wherein at least one of the sample dispensing module, the first reagent dispensing module, the first accumulation/incubation module, and the detection module comprises at least one of thermal control and humidity control.

67. An apparatus for detecting an analyte in a biological sample in a sample carrier with a plurality of wells, the apparatus comprising:
an optical measuring device comprising an upper optic assembly with a projecting element and a lower optic assembly for receiving the sample carrier;
wherein the optical measuring device encapsulates a biological sample in one of the plurality of wells of the sample carrier and detects energy from a chemistry of the biological sample to determine the amount of the analyte in the biological sample.

68. The apparatus of claim 67, wherein the optical measuring device of the detection module is an anidolic optical measuring device which detects energy from both uniform and non-uniform radiance patterns emitted by the chemistry of the biological sample.

69. The apparatus of claim 67, wherein the sample carrier is an integrating element.

70. The apparatus of claim 67, wherein the lower optic assembly comprises an integrating cup for receiving the sample carrier.

71. The apparatus of claim 70, wherein the integrating cup has a spherical shape and is optically diffusing.

72. The apparatus of claim 70, wherein the integrating cup is highly reflective.

73. The apparatus of claim 67, wherein the upper optic assembly comprises an excitation source for exciting the chemistry in the biological sample.

74. The apparatus of claim 73, wherein the excitation source is a laser.

75. The apparatus of claim 73, wherein the excitation source comprises a highly reflective excitation diffuser with a spherical shape.

76. The apparatus of claim 75, wherein the highly reflective excitation diffuser comprises a fiber optic tip shaped to emit sideways.

77. The apparatus of claim 76, wherein the fiber optic tip employs a plurality of facets.

78. The apparatus of claim 77, wherein the plurality of facets is 34 degrees from a central axis of the fiber optic tip.

79. The apparatus of claim 67, the anidolic optical measuring device comprising a plurality of filters for chemistries requiring multiplexing.

80. A method of detecting the amount of an analyte in a biological sample in a sample carrier with a plurality of wells, the method comprising:
feeding the sample carrier into a detection apparatus comprising an optical measuring device comprising an upper optic assembly with a projecting element and a lower optic assembly for receiving the sample carrier;
clamping the sample carrier between the lower optic assembly and the upper optic assembly to encapsulate a biological sample in one of the plurality of wells of the sample carrier; and
detecting energy from a chemistry of the biological sample to determine the amount of the analyte in the biological sample.

81. The method of claim 80, wherein the amount of a desired analyte in the biological sample is based on the strength of the emission of the chemistry in the biological sample.

82. The method of claim 80, wherein the detection apparatus is an anidolic optical measuring device which detects energy from both uniform and non-uniform radiance patterns emitted by the chemistry of the biological sample.
